(19) United States
(12) Patent Application Publication
(10) Pub. No.: US 2024/0126250 A1
(43) Pub. Date: Apr. 18, 2024

(54) PRODUCTION INFORMATION PROCESSING APPARATUS, PRODUCTION INFORMATION PROCESSING SYSTEM, AND PRODUCTION INFORMATION PROCESSING METHOD

(71) Applicant: Hitachi, Ltd., Tokyo (JP)

(72) Inventors: Daisuke TSUTSUMI, Tokyo (JP); Takahiro KOMIYAMA, Tokyo (JP)

(21) Appl. No.: 18/373,459

(22) Filed: Sep. 27, 2023

(30) Foreign Application Priority Data
Oct. 13, 2022 (JP) 2022-164560

(51) Int. Cl. G05B 23/02; G05B 19/418

(52) U.S. Cl. CPC G05B 23/0221; G05B 19/4183

(57) ABSTRACT

In a production information processing apparatus, a storage device stores a resource shared among a plurality of machines belonging to a predetermined manufacturing area, 4M data information that is time-series data of operating states per unit time of the machines and the resource related to the machines, and a production loss analysis model that defines a criterion for determining a production loss from a combination of the operating states per unit time in the 4M data information, and a processor identifies a production loss of each of the machines to generate production loss information, and combines the production loss information of one of the machines and 4M data information of another of the machines that is different from the machine and shares the resource, using the production loss information and the shared resource, to classify an occurrence factor of the production loss and generate loss occurrence factor information.

### CROSS-REFERENCE TO RELATED APPLICATION

The present application claims priority from Japanese application JP2022-164560, filed on Oct. 13, 2022, the content of which is hereby incorporated by reference into this application.

### BACKGROUND

### Technical Field

The present invention relates to a production information processing apparatus, a production information processing system, and a production information processing method.

### Related Art

One of the purposes of manufacturing management is to improve productivity. One method for enhancing productivity is to reduce a production loss. The “production loss” here is a generic term for various factors that inhibit the maximization of the output by a production system in production activities. In the present invention, the production loss is a concept commonly recognized in general activities such as total productive maintenance (TPM), and as a specific example, it refers to a factor that causes downtime of a production activity.

It is empirically known that production loss at a manufacturing site is caused not only by a machine (Machine) but also by a combination of states of a worker (Man) who performs a setup of the machine, a material (Material) input to the machine, a procedure and a program (Method) for operating the machine, and the like. However, in order to detect the production loss, enormous calculation resources for analyzing data indicating these states (4M data) are required. In addition, in actual production facilities, resources such as workers and materials are shared among a plurality of machines, and the productivity of the machines can be affected by each other.

JP 2018-036713 A discloses that “A cell controller 13 includes a first communication unit 18 which receives a task program and signal setting information stored in each manufacturing machine 11 from the manufacturing machine 11, a stop detection unit 22 which refers to the task program and the signal setting information to detect whether a production facility 12 has stopped operation, and a stop cause identification unit 23 which analyzes the task program and the signal setting information to identify the manufacturing machine 11 that has caused the operation stop of the production facility 12, and this cause”.

### SUMMARY

In the technology described in JP 2018-036713 A described above, it is possible to detect whether a production facility including a plurality of manufacturing machines has caused an operation stop, and to automatically identify a manufacturing machine causing the operation stop and a cause thereof. However, in the technology described in JP 2018-036713 A described above, for example, there is a case where it is not possible to identify the cause of losses caused by a worker who is in charge of a plurality of machines at the same time, a material having a work order relation between machines, or the like, and take any countermeasure against the loses.

An object of the present invention is to plan improvement measures based on an analysis of production losses, and to enhance productivity of an entire production area including a plurality of machines.

The present application includes a plurality of means for solving at least some of the above problems, and examples thereof are as follows.

One aspect of the present invention is a production information processing apparatus including: a processor; and a storage device, wherein the storage device stores: a shared resource that is a resource shared among a plurality of machines belonging to a predetermined manufacturing area; 4M (Machine, Man, Material, and Method) data information that is time-series data of operating states per unit time of the machines and the resource related to the machines; and a production loss analysis model that defines a criterion for determining a production loss from a combination of the operating states per unit time in the 4M data information, and the processor is configured to execute: identifying a production loss of each of the machines using the 4M data information and the production loss analysis model to generate production loss information; and combining the production loss information of one of the machines and 4M data information of another of the machines that is different from the machine and shares the resource, using the production loss information and the shared resource, to classify an occurrence factor of the production loss and generate loss occurrence factor information.

According to the present invention, it is possible to provide a technology for classifying factors that caused a production loss in an area including a plurality of machines sharing resources such as workers and materials, suggesting improvement measures, and enhancing the productivity of the entire area.

Problems, configurations, and advantageous effects other than those described above will be clarified by the following description of embodiments.

### BRIEF DESCRIPTION OF DRAWINGS

FIG. 1 is a diagram illustrating an example of a configuration of a production information processing apparatus;

FIG. 2 is a diagram illustrating an example of a usage mode of the production information processing apparatus;

FIG. 3 is a diagram illustrating an example of a hardware configuration of the production information processing apparatus;

FIG. 4 is a diagram illustrating an example of a data structure in a 4M data storage unit;

FIG. 5 is a diagram illustrating an example of a data structure in a production loss analysis model storage unit;

FIG. 6 is a diagram illustrating an example of a data structure in a production loss storage unit;

FIG. 7 is a diagram illustrating an example of a data structure in a shared resource storage unit;

FIG. 8 is a diagram illustrating an example of a data structure in a loss occurrence factor analysis model storage unit;

FIG. 9 is a diagram illustrating an example of a data structure in a loss occurrence factor storage unit;

FIG. 10 is a diagram illustrating an example of a data structure in an improvement measure storage unit;

FIG. 11 is a diagram illustrating an example of a flowchart of loss countermeasure plan suggestion processing;

FIG. 12 is a diagram illustrating a display example of loss occurrence factors;

FIG. 13 is a diagram illustrating an example of a flowchart of improvement measure derivation processing; and

FIG. 14 is a diagram illustrating a display example of improvement measures.

### DETAILED DESCRIPTION

In the following embodiment, the field data is indicated as 4M data: Man, Machine, Material, and Method, but the present invention is not limited thereto. For example, the field data may be 5M data (4M data+measurement: Measure) or 5M+E data (5M data+environment: Environment).

In the following embodiments, when necessary for the sake of convenience, the description will be divided into a plurality of sections or embodiments, but unless otherwise specified, the sections or embodiments are not unrelated to each other, and one is some or all modifications, details, supplementary explanation, and the like of the other.

In the following embodiments, when referring to the number of elements or the like (including number, numerical value, amount, range, and the like), the number is not limited to a specific number unless otherwise specified or obviously limited to the specific number in principle. The number may be equal to or greater than or less than the specific number.

In the following embodiments, it goes without saying that the components (including element steps and the like) are not necessarily essential unless otherwise specified or considered to be obviously essential in principle.

Similarly, in the following embodiments, when referring to the shapes, positional relationships, and the like of the components and the like, it is assumed that those substantially approximate or similar to the shapes and the like are included unless otherwise stated or unless clearly considered in principle. The same applies to the above numerical values and ranges.

In all the drawings for describing the embodiments, the same members are denoted by the same reference numerals in principle, and repeated description thereof will be omitted. However, the same member may be given different reference signs or names between before and after an environmental change in a case where there is a high possibility that the use of the same sign or name causes confusion. Hereinafter, embodiments of the present invention will be described with reference to the drawings.

In the following description, an “input/output unit”, a “display unit”, and an “interface device” may be one or more interface devices. The one or more interface devices may be at least one of the following:
One or more input/output (I/O) interface devices. The input/output (I/O) interface device is an interface device for at least one of the I/O device and a remote display computer. The I/O interface device for the display computer may be a communication interface device. The at least one I/O device may be any of a user interface device, for example, an input device such as a keyboard and a pointing device, and an output device such as a display device.
One or more communication interface devices. The one or more communication interface devices may be one or more communication interface devices of the same type (for example, one or more network interface cards (NIC)) or two or more communication interface devices of different types (for example, an NIC and a host bus adapter (HBA)).

In the following description, a “memory” is one or more memory devices that are an example of one or more storage devices, and may typically be a main storage device. The at least one memory device in the memory may be a volatile memory device or a nonvolatile memory device.

In the following description, the “persistent storage device” may be one or more permanent storage devices that are an example of one or more storage devices. The persistent storage device may typically be a nonvolatile storage device (for example, an auxiliary storage device), and specifically, may be a hard disk drive (HDD), a solid state drive (SSD), a non-volatile memory express (NVME) drive, or a storage class memory (SCM), for example.

In addition, in the following description, a “storage unit” or a “storage device” may be a memory or a memory and a persistent storage device.

In the following description, a “processing unit” or a “processor” may be one or more processor devices. The at least one processor device may typically be a microprocessor device such as a central processing unit (CPU), but may be another type of processor device such as a graphics processing unit (GPU). The at least one processor device may be a single core type or a multi-core type. The at least one processor device may be a processor core. The at least one processor device may be a processor device in a broad sense such as a circuit that is an aggregate of gate arrays in a hardware description language that performs some or all of processes (for example, a field-programmable gate array (FPGA), a complex programmable logic device (CPLD), or an application specific integrated circuit (ASIC)).

In the following description, a function may be described using an expression “yyy unit”, but the function may be implemented by a processor executing one or more computer programs, may be implemented by one or more hardware circuits (for example, FPGA or ASIC), or may be implemented by a combination thereof. In a case where the function is implemented by a processor executing a program, the determined processing is performed as appropriate using a storage device and/or an interface device. Thus, the function may be regarded as at least a part of the processor. The processing described as being performed by the function may be processing performed by a processor or a device including the processor. The program may be installed from a program source. The program source may be a program distribution computer or a computer-readable recording medium (for example, a non-transitory recording medium), for example. The description of each function is an example, and a plurality of functions may be integrated into one function or one function may be divided into a plurality of functions.

In the following description, processing may be described as being performed by a “program” or a “processing unit”. The processing described as being performed by a program may be processing performed by a processor or a device including the processor. Two or more programs may be implemented as one program, or one program may be implemented as two or more programs.

In the following description, information of which an output is obtained with respect to an input may be described with an expression such as “xxx table”. However, the information may be a table of any structure, or may be a learning model represented by a neural network, a genetic algorithm, or a random forest, which generates an output with respect to an input. Therefore, the “xxx table” can be called “xxx information”. In the following description, the configuration of each table is an example, and one table may be divided into two or more tables, or all or some of two or more tables may be one table.

In the following description, a “system” may be a system including one or more physical computers, or may be a system (for example, a cloud computing system) implemented on a physical calculation resource group (for example, a cloud infrastructure). That the production information processing apparatus “displays” information for display may mean that the information for display is displayed on a display device included in a computer, or that the computer transmits the information for display to a display computer (in the latter case, the information for display is displayed on the display computer).

[First Embodiment] In the present embodiment, as an example, factors causing production losses are classified in a production area including a plurality of machines sharing resources such as workers and materials, and improvement measures are suggested.

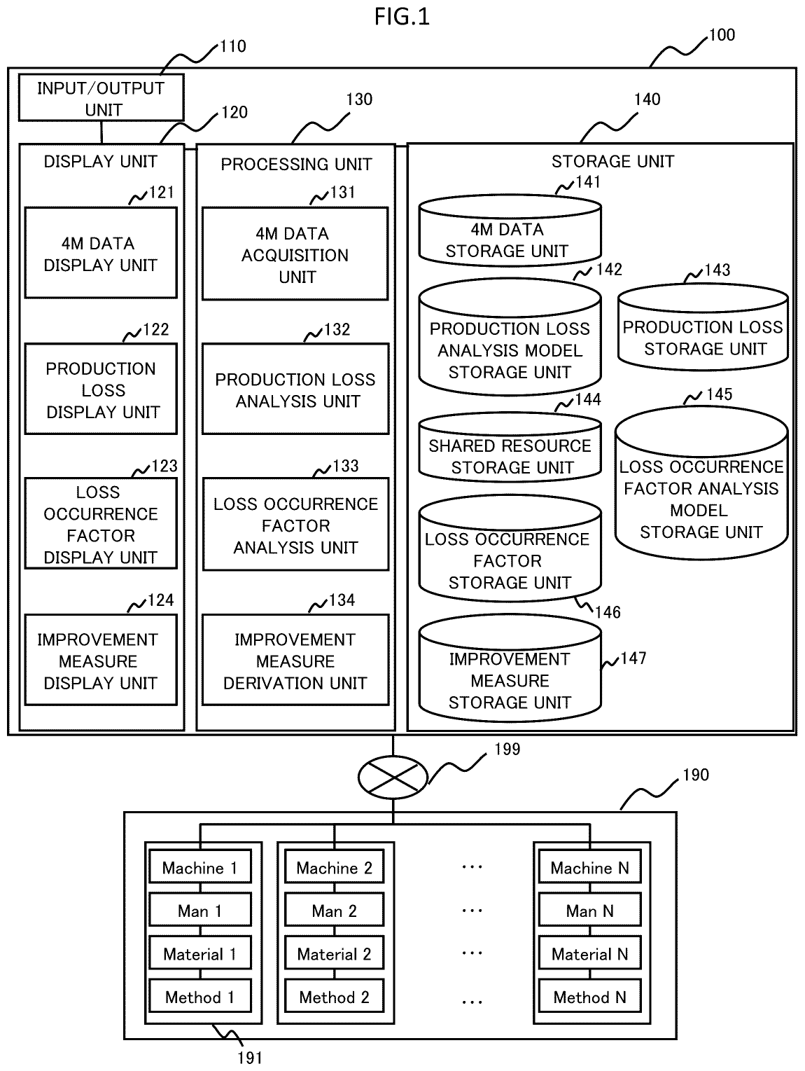

FIG. 1 is a diagram illustrating an example of a configuration of a production information processing apparatus. A production information processing apparatus 100 includes an input/output unit 110, a display unit 120, a processing unit 130, and a storage unit 140. The display unit 120 includes a 4M data display unit 121, a production loss display unit 122, a loss occurrence factor display unit 123, and an improvement measure display unit 124. The display unit 120 is a type of processing unit that performs presentation processing on information to be displayed on an output screen to produce screen output, and performs screen control on operations input on the screen, such as scrolling, sorting, and highlight display.

The processing unit 130 includes a 4M data acquisition unit 131, a production loss analysis unit 132, a loss occurrence factor analysis unit 133, and an improvement measure derivation unit 134.

The storage unit 140 includes a 4M data storage unit 141, a production loss analysis model storage unit 142, a production loss storage unit 143, a shared resource storage unit 144, a loss occurrence factor analysis model storage unit 145, a loss occurrence factor storage unit 146, and an improvement measure storage unit 147.

The production information processing apparatus 100 is connected to a manufacturing site 190 via a communication network (for example, a local area network (LAN), a wide area network (WAN), or the Internet) 199. The communication network 199 may be any one of a virtual private network (VPN), a communication network partially or entirely using a general public line such as the Internet, a mobile phone communication network, and the like, or a combined network thereof, for example. The communication network 199 may be a wireless communication network such as Wi-Fi (registered trademark) or 5G (Generation).

At the manufacturing site 190, there is a manufacturing system (for example, a line manufacturing system, a job shop manufacturing system, or a cell manufacturing system). The manufacturing system is provided with one or a plurality of manufacturing facilities 191, for example.

The manufacturing facility 191 is provided with a Machine management device that manages elements (for example, machine tools and robots) belonging to Machine, a Material management device that manages elements (for example, workpieces) belonging to Material, a Method management device that manages elements (for example, tools) belonging to Method, and a Man management device that manages elements (for example, workers) belonging to Man. In the present embodiment, for simplification of the description, it is assumed that elements belonging to Material are workpieces, elements belonging to Method are tools, and elements belonging to Man are workers.

Data measured by various management devices at the manufacturing site 190 (for example, data including measurement times and measurement values) is sent from the plurality of devices to the 4M data storage unit 141 through the gateway and stored therein.

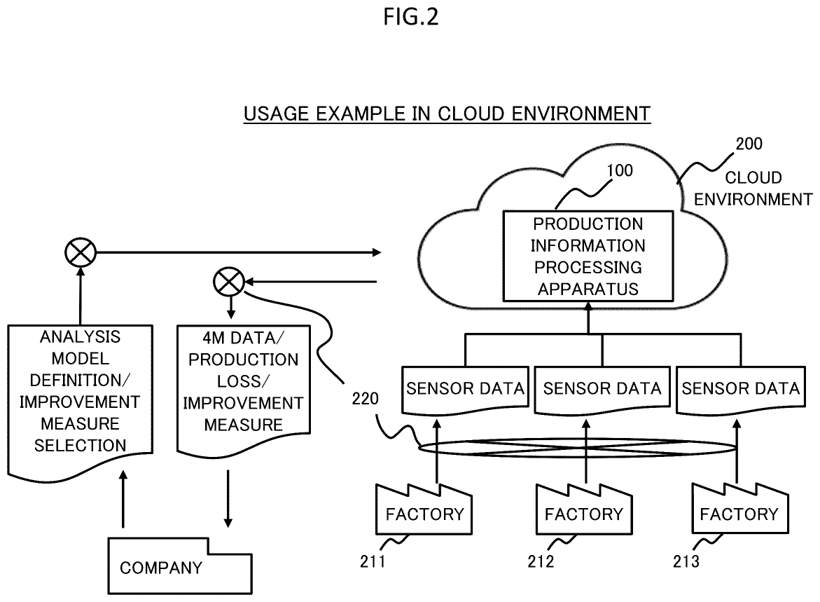

FIG. 2 is a diagram illustrating an example of a usage mode of the production information processing apparatus. The production information processing apparatus 100 in a cloud environment 200 accepts (receives) input information related to production at all factories 211, 212, and 213 capable of production via a network 220 such as the Internet, and outputs (transmits) improvement measure information suitable for each production line at all the factories 211, 212, and 213 via the network 220, so that it is possible to prescribe optimal improvement measures in consideration of the production lines at all the producible factories 211, 212, and 213. All the production-capable factories may include own factories, other companies' factories, and both own and other companies' factories.

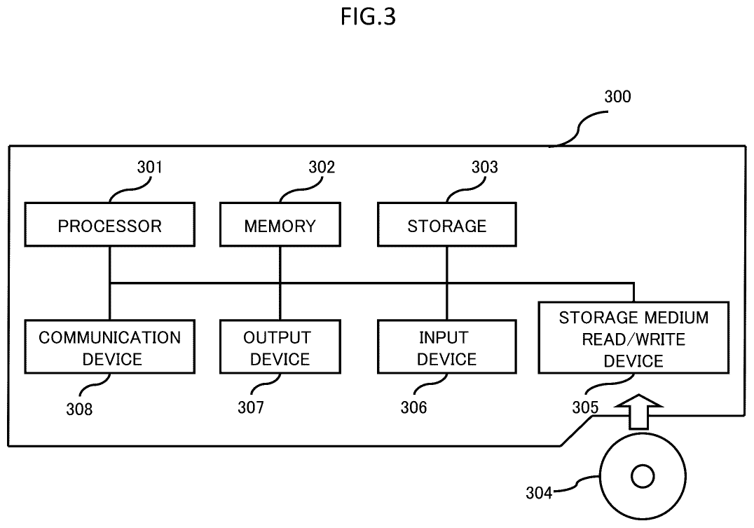

FIG. 3 is a diagram illustrating an example of a hardware configuration of the production information processing apparatus. The production information processing apparatus 100 can be implemented by a general computer 300 that includes a processor 301, a memory 302, a storage 303 such as a hard disk drive (HDD), a storage medium read/write device 305 that reads or writes information from or into a portable storage medium 304 such as a compact disk (CD) or a digital versatile disk (DVD), an input device 306 such as a keyboard, a mouse, or a bar code reader, an output device 307 such as a display, and a communication device 308 that communicates with another computer via a communication network such as the Internet, or a network system including a plurality of the computers 300.

For example, the processing unit 130 can be implemented by loading a predetermined program stored in the storage 303 into the memory 302 and executing the program by the processor 301. The input/output unit 110 can be implemented by the processor 301 using the input device 306 and the output device 307. The storage unit 140 can be implemented by the processor 301 using the memory 302 or the storage 303.

The predetermined program may be downloaded to the storage 303 from the storage medium 304 via the storage medium read/write device 305 or from a network via the communication device 308, then loaded onto the memory 302, and executed by the processor 301.

Furthermore, the predetermined program may be directly loaded onto the memory 302 from the storage medium 304 via the storage medium read/write device 305 or from a network via the communication device 308 and executed by the processor 301.

The present invention is not limited thereto, and the production information processing apparatus 100 may be a wearable computer worn by a worker, such as a headset, goggles, glasses, or an intercom, for example.

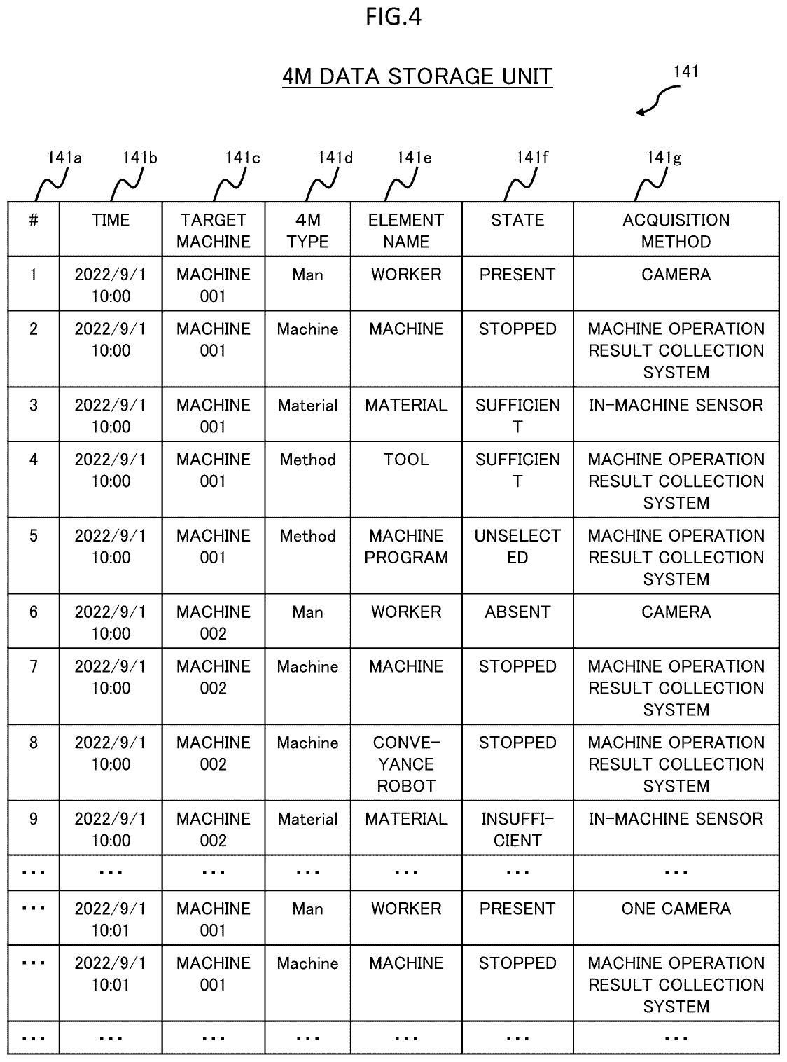

FIG. 4 is a diagram illustrating an example of a data structure in a 4M data storage unit. The 4M data is time-series data of an operating state per unit time of a plurality of machines belonging to the manufacturing area and resources related to the machines. For example, in the 4M data storage unit 141, data indicating the state of 4M (for example, the acquired state and the acquisition method based on 4M type and element name) related to target machines (for example, “machine 001” and “machine 002”) is collected and recorded periodically (for example, every minute).

Each record 141a in the 4M data storage unit 141 associates a time 141b, a target machine 141c, a 4M type 141d, an element name 141e, a state 141f, and an acquisition method 141g. The time 141b is information for specifying the start time of the period during which the 4M data was acquired. The target machine 141c is information for specifying a target machine of interest. The 4M type 141d is information indicating any M of the 4M. The element name 141e is information for specifying the name of the element belonging to the M. The state 141f is information for specifying the state of the element. The acquisition method 141g is information for specifying a data acquisition method.

For example, the example of a data row #1indicates for Man that the worker was “present” (was working with “machine 001”) from 10:00 on September 1 to 10:01 on September 1. The example of the data row #2 indicates for Machine that the “machine 001” was stopped from 10:00 on September 1 to 10:01 on September 1.

According to the 4M data storage unit 141, a combination of resource states for each time (for example, for each minute) is specified. For each of viewpoints of 4M, the state of an element belonging to the viewpoint of M may be a state described in the data collected from the manufacturing site 190, or may be a state specified using the measurement value described in the collected data.

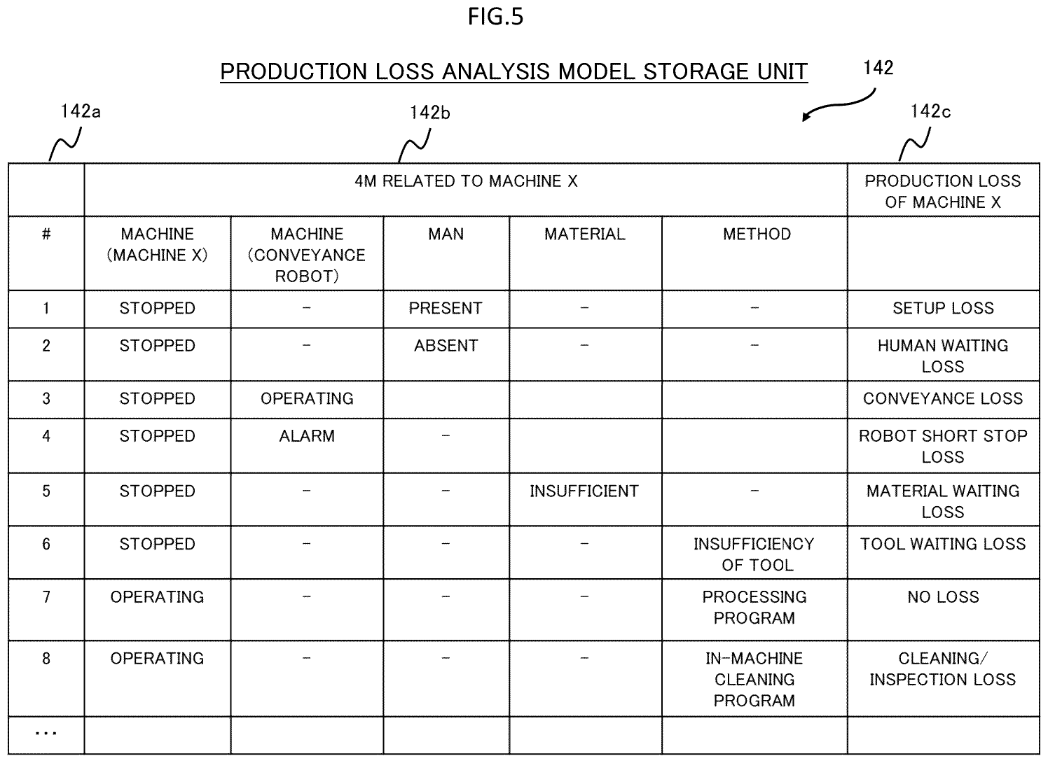

FIG. 5 is a diagram illustrating an example of a data structure in the production loss analysis model storage unit. The production loss analysis model defines a criterion for determining a production loss from a combination of operating states per unit time in 4M data information. Specifically, the production loss analysis model is a model that, taking a machine X as the main element, defines a production loss of the machine X from a combination of states of the machine X and related 4M. More specifically, the production loss analysis model storage unit 142 has a record with each record number 142a representing a correspondence relationship analyzed in advance between a 4M 142b related to the machine X and a production loss 142c of the machine X, which is a state combination (a combination of 4M states). One row of the production loss analysis model storage unit 142 represents a correspondence relationship between one state combination and one production loss. The state “−” means an unspecified state.

The state combination is data in which acquired 4M data is collected at each identical time (unit time treated as identical), that is, in time series. According to the example illustrated in FIG. 5, the presence/absence of a worker in the work area of the machine X is used as 4M data for “Man”, the operating/stoppage of the machine X and the conveyance robot is used as 4M data for “Machine”, the sufficiency or insufficiency of the material to be processed by the machine X is used as 4M data for “Material”, the sufficiency or insufficiency of the tool and the operating state of the machine program (such as under in-machine cleaning program processing) are used as 4M data for “Method”, and the like.

For example, according to the example of the data row #1, “setup loss” indicates that the stopped state of the machine X for Machine and the state of the presence of Man (working with the machine X) are combined. The example of the data row #2 indicates that if the machine X is stopped for Machine as in #1 but Man is absent, a “human waiting loss” occurs.

In the present embodiment, the correspondence between the production loss and the state combination is illustrated as an example in a table format.

Alternatively, the correspondence may be defined in another format. For example, it may be defined in XML format according to a Decision Model and Notation (DMN) standard. This method facilitates implementation by a computer program.

Regarding the state combination, each state of 4M may be defined by a decision tree in which each state is branched and a final arrival point is a production loss. This method facilitates visual interpretation of the production loss analysis model.

In the present embodiment, the production loss analysis model storage unit 142 is prepared in advance with the state combination as an input and with the production loss as an output. Instead of this, a learned model (for example, a neural network) may be used with the state combination as an input and with the production loss as an output.

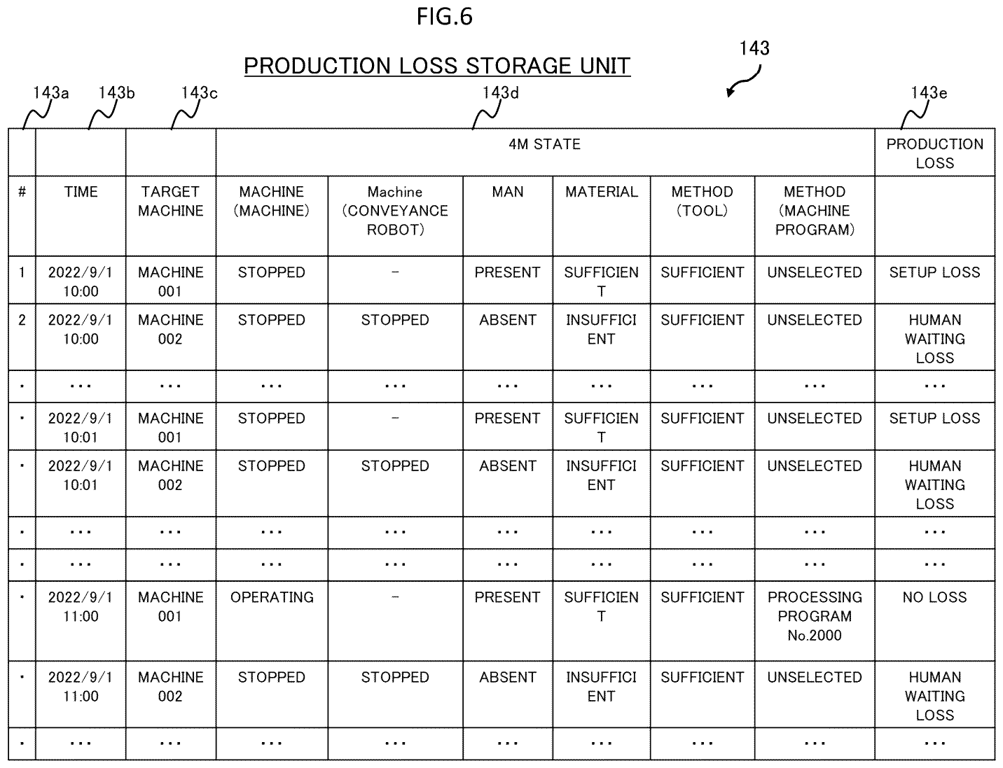

FIG. 6 is a diagram illustrating an example of a data structure in the production loss storage unit. For each target machine 143c, the production loss storage unit 143 has a record with each record number 143a that associates the determination results of a 4M state 143d and a production loss 143e for each time 143b.

Regarding the production loss information, the production loss analysis unit 132 receives the 4M data information in the 4M data storage unit 141 as an input, and outputs an analysis result of the production loss per unit time (for example, one minute) of analysis, based on the production loss analysis model information in the production loss analysis model storage unit 142. The production loss analysis unit 132 stores the analysis result in the production loss storage unit 143.

For example, according to the example of the data row #1, the information of the target machine “machine 001” at the time“2022/9/1 10:00” is acquired from the data rows #1 to 5 in the 4M data storage unit 141 in FIG. 4. The production loss analysis unit 132 analyzes that the state in the 4M data corresponds to a “setup loss” defined by the data row #1 in the production loss analysis model storage unit 142 in FIG. 5. The data “−” of the 4M state 143d in the production loss storage unit 143 means that there is no corresponding data in the target machine.

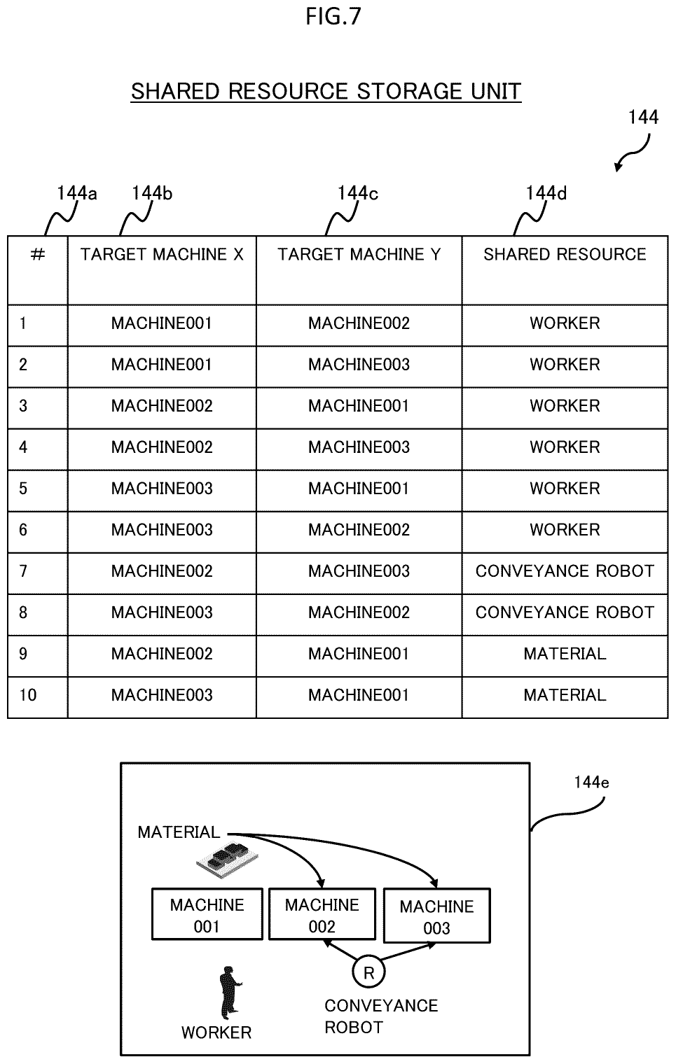

FIG. 7 is a diagram illustrating an example of a data structure in the shared resource storage unit 144. The shared resource is information in which resources shared by each combination of two or more machines are associated with each other. Herein, an example of the shared resource storage unit 144 that defines a relationship between machines having shared resources will be described by exemplifying a production area 144e.

The production area 144e includes three machines “machine 001”, “machine 002”, and “machine 003”. One transfer robot R (Machine) performs setup work of the “machine 002” and the “machine 003”. These facilities are managed by one worker (Man). It is assumed that the material (Material) processed by the “machine 001” is additionally processed by the “machine 002” or the “machine 003”.

In such an example, the resources shared by the plurality of machines include a worker, a robot, and a material. In the shared resource storage unit 144, shared resources are defined for a combination of two machines.

Specifically, the shared resource storage unit 144 has a record with each record number 144a that associates a shared resource 144d with a combination of a target machine X 144b and a target machine Y 144c. The target machine X and the target machine Y are machines that provide added value. In other words, the target machines are machines that directly contribute to productivity. Machines performing auxiliary functions such as a transfer robot are not target machines but shared resources.

For example, according to the example of the data row #1, the “worker” is set as the shared resource for the combination of the “machine 001” and the “machine 002”. In this example, the worker may work with the “machine 002” after the work with the “machine 001”, or may work with the “machine 001” again after the work with the “machine 002”. Therefore, data (in data row #3) is also defined in which the target machines X and Y are interchanged. The worker is in charge of all of the “machine 001”, the “machine 002”, and the “machine 003”. Therefore, the worker is defined as the shared resource not only for the combination of “machine 001” and “machine 002” but also for the combination of “machine 001” and “machine 003” (data rows #2 and #5) and the combination of “machine 002” and “machine 003” (data rows #4 and #6).

Further, according to the example of the data row #9, the “machine 002” shares a material with the “machine 001”. In this example, the material is processed by the “machine 001” (target machine Y) before working by the “machine 002” (target machine X), and the operating state of the “machine 002” is affected by the processing status of the material by the “machine 001”. On the other hand, the “machine 001” is not affected by the processing status of the material by the “machine 002”. Therefore, the data in which the target machine X and the target machine Y are interchanged is not defined in the data row #9. In other words, since the “machine 002” is affected by the processing status of the material by the “machine 001”, the definition of sharing the material with the “machine 001” is required for the “machine 002”, but is not required for the opposite. Thus, the interchanged definition is unnecessary.

Candidates for the resources shared between the machines are all 4M elements at the production site. For example, robots and AGVs may apply for Machine, workers apply for Man, materials may apply for Material, and tools, machine programs, or the like may apply for Method.

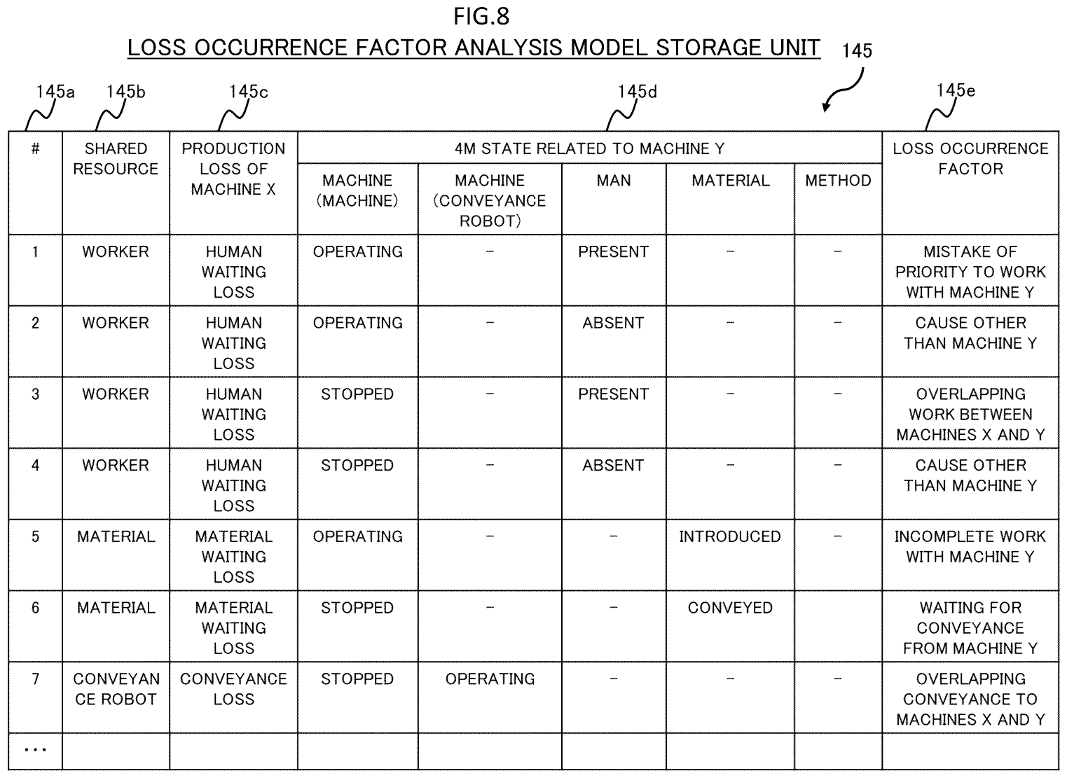

FIG. 8 is a diagram illustrating an example of a data structure in the loss occurrence factor analysis model storage unit. The loss occurrence factor analysis model storage unit 145 stores a loss occurrence factor analysis model that defines a criterion for determining an occurrence factor of a production loss from a combination of production loss information of a machine and an operating state per unit time of another machine different from the machine and sharing a resource in 4M data information. That is, the loss occurrence factor analysis model storage unit 145 defines a loss occurrence factor for a combination of two machines X and Y. More specifically, in the loss occurrence factor analysis model storage unit 145, each shared resource 145b is associated in advance with a loss occurrence factor 145e corresponding to a combination of a production loss 145c of the machine X and a 4M state 145d related to the machine Y. The data “−” included in the 4M state 145d related to the machine Y means an unspecified state.

For example, according to the example of the data row #1, when a production loss detected in the machine X is “human waiting loss”, if the 4M state related to the machine Y is a predetermined state, that is, a state in which the machine Y is in operation for Machine and the worker is present (working with the machine Y) for Man, the definition is such that the loss occurrence factor of the “human waiting loss” in the machine X is “mistake of priority to work with machine Y”. The “mistake of priority to work with machine Y” here refers to a state in which the human-waiting loss occurred in the machine X because the worker, who is the shared resource, gave priority to working with the machine Y in operation rather than working for operating the stopped machine X.

In the example of the loss occurrence factor analysis model storage unit 145, as the loss occurrence factor 145e, in addition to “mistake of priority to work with machine Y”, “overlapping work between machines X and Y”, “incomplete work with machine Y”, “overlapping conveyance to machines X and Y”, “waiting for conveyance from machine Y”, and “cause other than machine Y” are defined. For example, “overlapping work between the machines X and Y” indicates a state in which both the machine X and the machine Y are stopped and need setup work by the worker, and a state in which the work necessary states overlap at the identical time. In addition, a loss occurrence factor other than those in this example may be defined.

That is, according to the model definition stored in the loss occurrence factor analysis model storage unit 145, it can be said that the factors causing a production loss of the machine X can be uniquely classified according to the 4M state for the different machine Y sharing the resource.

In the present embodiment, in the model definition stored in the loss occurrence factor analysis model storage unit 145, the loss occurrence factor is defined using the production loss of the machine X and the data of the 4M state for the machine Y. However, the present invention is not limited thereto, and the model definition stored in the loss occurrence factor analysis model storage unit 145 may use the data of 4M state for the machine X, which is original data for analyzing the production loss, instead of the production loss of the machine X. Alternatively, the model definition stored in the loss occurrence factor analysis model storage unit 145 may use a production loss analyzed from the data of the 4M state for the machine Y, instead of the production loss of the machine Y. The model definition stored in the loss occurrence factor analysis model storage unit 145 may define three or more machines as a combination of machines.

In the present embodiment, the model definition stored in the loss occurrence factor analysis model storage unit 145 defines a combination of the shared resource 145b, the production loss 145c of the machine X, the 4M state 145d related to the machine Y, and the loss occurrence factor 145e in a table format. However, the combination may be defined in another format. For example, the model definition stored in the loss occurrence factor analysis model storage unit 145 may be made in an XML format according to a Decision Model and Notation (DMN) standard. This method facilitates implementation by a computer program.

The model definition stored in the loss occurrence factor analysis model storage unit 145 may be defined by a decision tree in which each piece of information of the shared resource 145b of the machines X and Y, the production loss 145c of the machine X, and the 4M state 145d related to the machine Y is branched, and the final arrival point is set as the loss occurrence factor 145e. This method facilitates visual interpretation of the loss occurrence factor analysis model.

In the present embodiment, as the model definition stored in the loss occurrence factor analysis model storage unit 145, the loss occurrence factor analysis model storage unit 145 is prepared in advance with a combination of the shared resources 145b of the machines X and Y, the production loss 145c of the machine X, and the 4M state 145d related to the machine Y as an input and with the loss occurrence factor 145e as an output. However, instead of this, a learned model (for example, a neural network) may be used with a combination of the shared resource 145b of the machines X and Y, the production loss 145c of the machine X, and the 4M state 145d related to the machine Y as an input and with the loss occurrence factor 145e as an output.

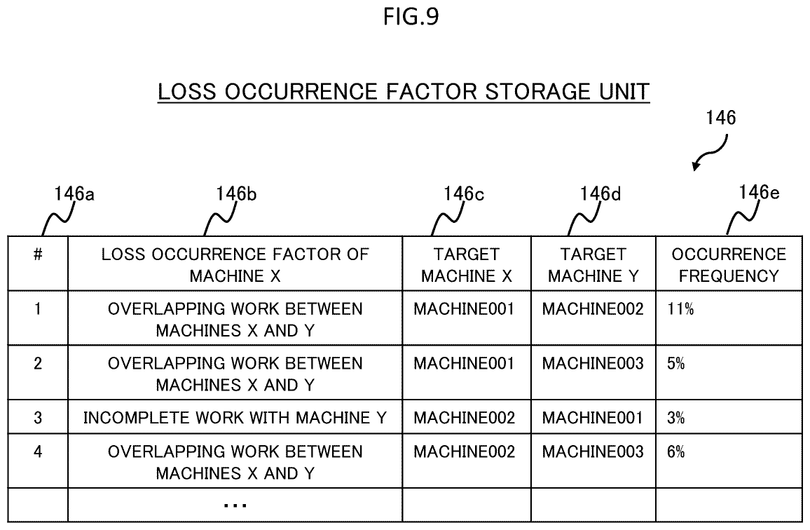

FIG. 9 is a diagram illustrating an example of a data structure in the loss occurrence factor storage unit. The loss occurrence factor storage unit 146 stores a loss occurrence factor for a combination of target machines (for example, “machine 001” and “machine 002”) sharing a resource, as a statistic of an occurrence frequency in an analysis target period (for example, 24 hours).

More specifically, the loss occurrence factor storage unit 146 has a record with each record number 146a that associates a loss occurrence factor 146b, a combination of a target machine X 146c and a target machine Y 146d, and an occurrence frequency 146e. The loss occurrence factor storage unit 146 stores a result of analyzing a loss occurrence factor per unit time (for example, one minute) of analysis by the loss occurrence factor analysis unit 133. The loss occurrence factor analysis unit 133 receives the production loss information of the production loss storage unit 143, the 4M data information in the 4M data storage unit 141, and the shared resource information of the shared resource storage unit 144 as inputs, and analyzes the loss occurrence factor for each shared resource based on the loss occurrence factor analysis model information in the loss occurrence factor analysis model storage unit 145. The loss occurrence factor analysis unit 133 aggregates the loss occurrence factors in the analysis target period for each combination of target machines and stores the same in the loss occurrence factor storage unit 146.

For example, according to the example of the data row #1, in the combination of the “machine 001” and the “machine 002” as the target machines, it is indicated that the production loss of the “machine 001” having the “overlapping work between machines X and Y” as the loss occurrence factor occurred at 11% in the analysis target period. The occurrence frequency is a value obtained by dividing the downtime of the machine due to the loss by the entire period, but is not limited thereto. The occurrence frequency may be the number of operation stops within the period.

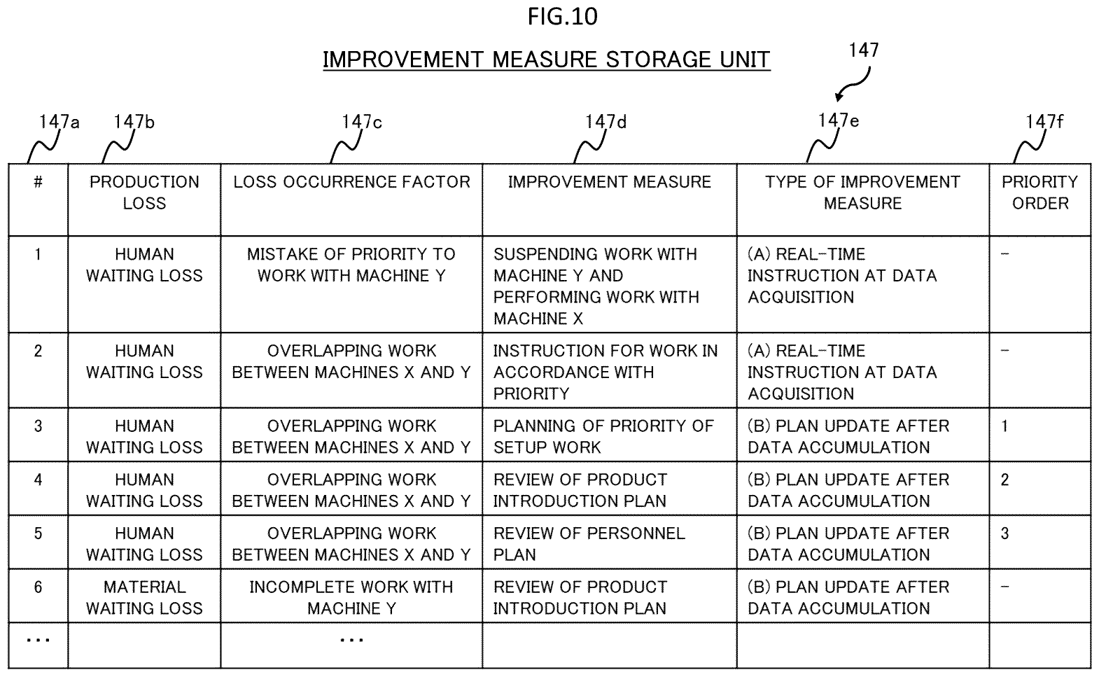

FIG. 10 is a diagram illustrating an example of a data structure in the improvement measure storage unit 147. The improvement measure storage unit 147 defines a target production loss and a suggestion of an improvement measure against an occurrence factor of the production loss. As for the improvement measure, one or more improvement measures are defined against one type of production loss, and the type and priority of the improvement measure(s) are defined.

More specifically, the improvement measure storage unit 147 defines a target production loss 147b, a loss occurrence factor 147c, an improvement measure 147d against a combination of the loss and the occurrence factor, an improvement measure type 147e, and a measure priority order 147f. FIG. 10 illustrates, as the type 147e of improvement measure, an example of two types of “(A) real-time instruction at the time of data acquisition” by which a production loss can be handled immediately upon detection, and “(B) plan update after data accumulation” by which a measure is reflected in a future plan based on statistics in an analysis target period.

The priority order 147f is information indicating the order of priority of application in a case where there is a plurality of improvement measures for identical combinations in production loss, loss occurrence factor, and type of improvement measure (for example, data rows #3 to #5).

Improvement measure may overlap for combinations different in production loss and loss occurrence factor (for example, data rows #4 and #6). This is because there is an effective improvement measure for different loss occurrence factors.

The 4M data acquisition unit 131 acquires 4M data of machines to be analyzed from the 4M data storage unit 141.

The production loss analysis unit 132 identifies the production loss of each machine using the information in the 4M data storage unit 141 and the information in the production loss analysis model storage unit 142, generates the production loss information, and stores the production loss information in the production loss storage unit 143.

Using the information in the production loss storage unit 143 and the information in the shared resource storage unit 144, the loss occurrence factor analysis unit 133 combines the production loss information of the machine and the 4M data information of another machine that is different from the machine and shares the resource, classifies the occurrence factor of the production loss, generates the loss occurrence factor information, and stores the loss occurrence factor information in the loss occurrence factor storage unit 146. In other words, the loss occurrence factor analysis unit 133 classifies the occurrence factor of the production loss using the loss occurrence factor analysis model.

The improvement measure derivation unit 134 performs an improvement measure derivation process described later, and suggests the improvement measures for the combination of a plurality of machines in accordance with priority based on the analyzed loss occurrence factors.

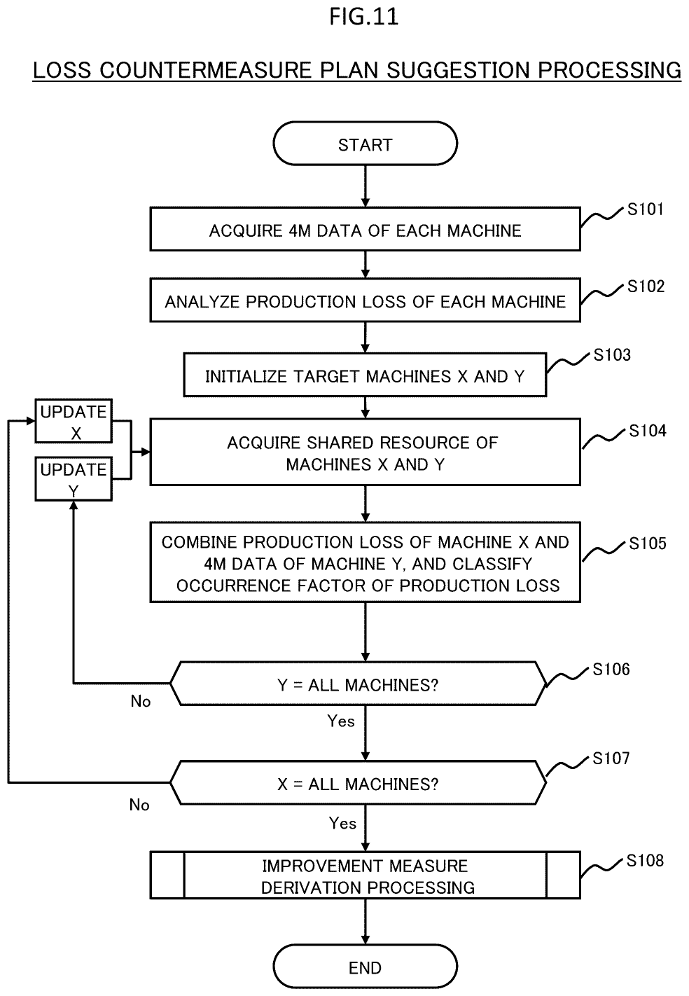

FIG. 11 is a diagram illustrating an example of a flowchart of the loss countermeasure plan suggestion processing. The loss countermeasure plan suggestion processing is started upon receipt of a start instruction from the user via the interface device.

First, the 4M data acquisition unit 131 acquires 4M data of each machine to be analyzed from the 4M data storage unit 141 (step S101). The 4M data acquisition unit 131 may display the 4M data via the 4M data display unit 121 to cause the user to confirm the acquired 4M data of each machine.

The production loss analysis unit 132 acquires the production loss analysis model from the production loss analysis model storage unit 142, analyzes the production loss of each machine with respect to the 4M data acquired in step S101, and stores the analysis results in the production loss storage unit 143 (step S102).

Specifically, if the state of 4M defined in the production loss analysis model is included in the acquired 4M data, the production loss analysis unit 132 determines that there is a production loss and stores the analysis results in the production loss storage unit 143. The production loss analysis unit 132 may display the analysis results of the production loss of each machine via the production loss display unit 122 to cause the user to confirm the analysis results.

The loss occurrence factor analysis unit 133 initializes a combination of machines X and Y to be analyzed for a loss occurrence factor (step S103). For example, the loss occurrence factor analysis unit 133 sets “machine 001” as the machine X and “machine 002” as the machine Y.

The loss occurrence factor analysis unit 133 then acquires the shared resource(s) of the machine X and the machine Y from the shared resource storage unit 144 (step S104). For example, if the “machine 001” is set as the machine X and the “machine 002” is set as the machine Y, in the example of the shared resource storage unit 144 in FIG. 7, only the worker (data row #1) is acquired as the shared resource. If the “machine 003” is set as the machine X and “machine 001” is set as the machine Y, in the example of the shared resource storage unit 144 in FIG. 7, the worker (data row #5) and the material (data row #10) are acquired as the shared resources.

Then, the loss occurrence factor analysis unit 133 combines the production loss of the machine X and the 4M data of the machine Y, and classifies the occurrence factor of the production loss (step S105). Specifically, the loss occurrence factor analysis unit 133 acquires the loss occurrence factor analysis model from the loss occurrence factor analysis model storage unit 145. The loss occurrence factor analysis unit 133 then inquires of the loss occurrence factor analysis model about the loss occurrence factor according to the combination of the 4M data acquired in step S101, the production loss data output in step S102, and the data of the shared resource acquired in step S104, and analyzes the loss occurrence factor. The loss occurrence factor analysis unit 133 stores the analysis results in the loss occurrence factor storage unit 146.

The loss occurrence factor analysis unit 133 may display the analysis results of the loss occurrence factor via the loss occurrence factor display unit 123 to cause the user to confirm the analysis results. The loss occurrence factor display unit 123 displays the production loss of the target machine and the loss occurrence factor in parallel in time series together with the states of the other machine sharing the resource with the machine and the shared resource.

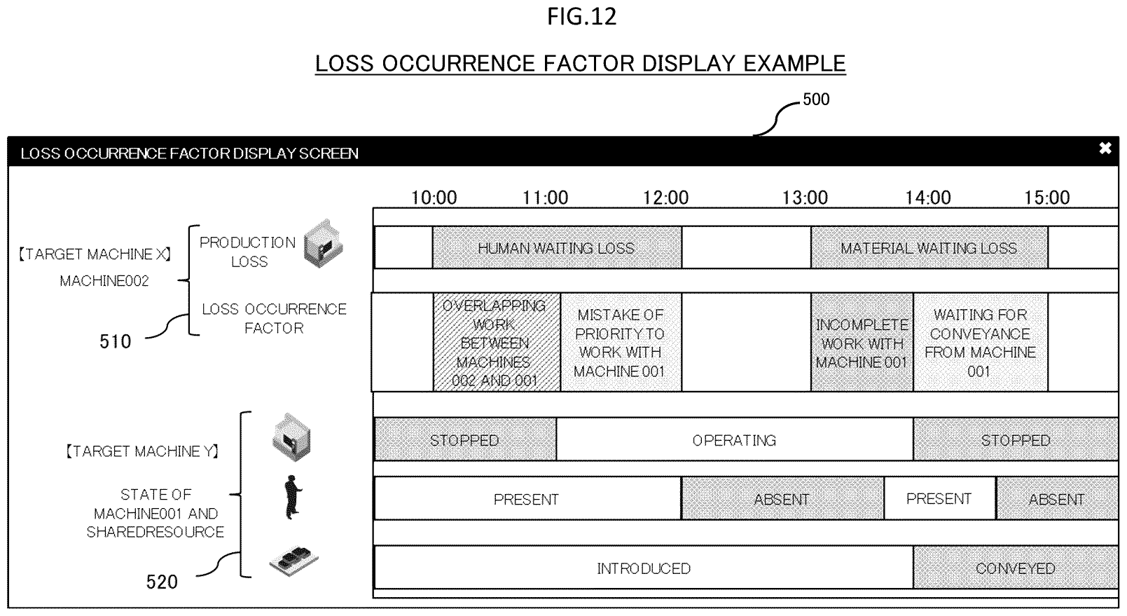

FIG. 12 is a diagram illustrating a display example of loss occurrence factors. The loss occurrence factor display screen 500 is an example in which the loss occurrence factor display unit 123 displays the production losses of the target machine and the loss occurrence factors 510 in parallel in time series together with the machine sharing the resource and the states 520 of the shared resources. In the example of the loss occurrence factor display screen 500, the “machine 002” is set as the target machine X, and the “machine 001” is set as the target machine Y.

In this example, the “machine 002” has a human waiting loss during “10:00 to 12:00”. In the example of the shared resource storage unit 144 in FIG. 7, the “machine 002” shares a worker and a material as resources with the “machine 001”. According to the example of the loss occurrence factor analysis model storage unit 145 in FIG. 8, if the worker is a shared resource and a human waiting loss has occurred in the machine X (“machine 002”) in a state where the machine Y (“machine 001”) is “stopped” for Machine and the worker is “present” for Man (that is, the data row #3), the loss occurrence factor analysis unit 133 analyzes that the loss occurrence factor of the machine X (“machine 002”) is “overlapping work between machines X and Y”. As a result, on the loss occurrence factor display screen 500, “overlapping work between machines 002 and 001” is displayed as the loss occurrence factor at “10:00 to 11:00” among the human waiting losses at “10:00 to 12:00”.

Similarly, if the worker is a shared resource and a human waiting loss has occurred in the machine X (“machine 002”) in a case where the machine Y (“machine 001”) is “operating” for Machine and the worker is “present” for Man (that is, the data row #1), the loss occurrence factor analysis unit 133 analyzes that the loss occurrence factor of the machine X (“machine 002”) is “mistake of priority to work with the machine Y”. As a result, on the loss occurrence factor display screen 500, “mistake of priority to work with the machine 001” is displayed as the loss occurrence factor during “11:00 to 12:00” among the human waiting losses at “10:00 to 12:00”.

On the loss occurrence factor display screen 500, the production losses of the target machine can be classified and displayed by the loss occurrence factor. In addition, on the loss occurrence factor display screen 500, the reasons for classification of the loss occurrence factors can be displayed in parallel with the 4M data of the machine sharing the resource. That is, the loss occurrence factor display screen 500 informs the user of the occurrence of production losses resulting from the relationship between the plurality of machines and the occurrence factors together with the 4M data, so that the user can easily grasp the situation. In the example of the loss occurrence factor display screen 500, the loss occurrence factors between the “machine 002” and the “machine 001” are displayed as a target. However, the present invention is not limited thereto. The loss occurrence factors between the “machine 002” and the “machine 003” may be displayed as a target, or all of them may be displayed in list form. The description returns to the flowchart in FIG. 11.

The loss occurrence factor analysis unit 133 determines whether all the machines combinable with the machine X have been selected (step S106). If there is an unselected machine (“No” in step S106), the loss occurrence factor analysis unit 133 updates the machine Y to the unselected machine, and returns the control to step S104. If all the candidate machines of the machine Y have been selected (“Yes” in step S106), the loss occurrence factor analysis unit 133 moves the control to step S107.

The loss occurrence factor analysis unit 133 determines whether all the machines have been selected as the machine X (step S107). If there is an unselected machine (“No” in step S107), the loss occurrence factor analysis unit 133 updates the machine X to the selected machine, and returns the control to step S104. If all the candidate machines of the machine X have been selected (“Yes” in step S107), the loss occurrence factor analysis unit 133 moves the control to step S108.

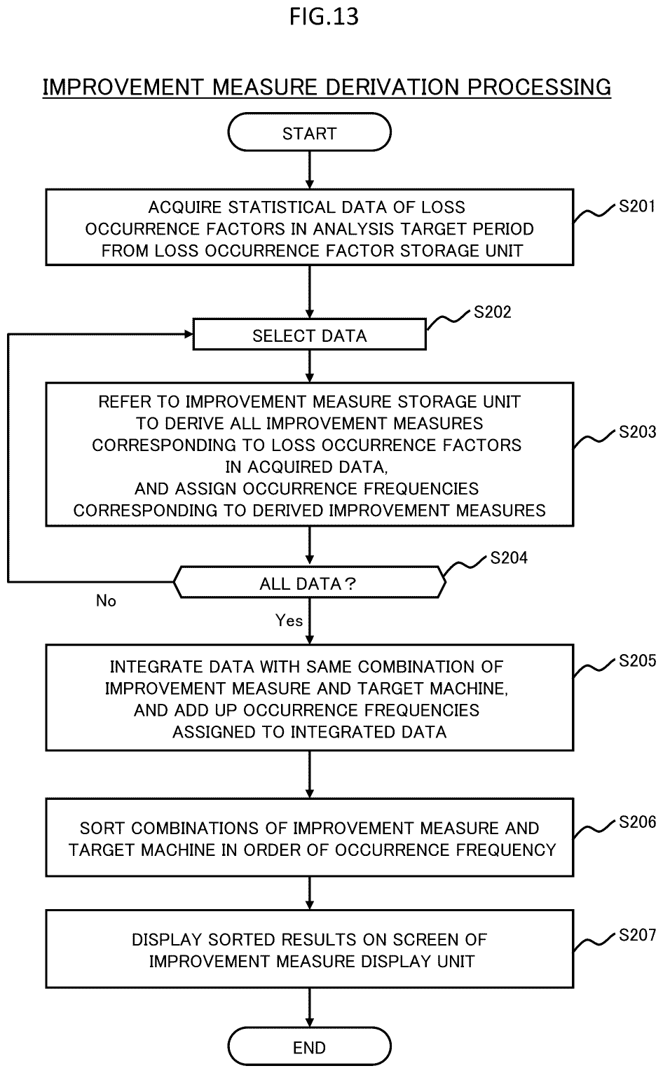

The improvement measure derivation unit 134 executes improvement measure deriving processing (step S108). The improvement measure derivation unit 134 ends the loss countermeasure plan suggestion processing. The improvement measure deriving processing will be described with reference to the flowchart in FIG. 13.

The above is an example of the flow of the loss countermeasure plan suggestion processing. According to the loss countermeasure plan suggestion processing, in a production area constituted by a plurality of machines sharing resources such as workers and materials, it is possible to not only identify production losses of a single machine but also cross-analyze production losses of a plurality of machines sharing resources and 4M data, thereby to classify occurrence factors of the production losses due to correlation factors of the plurality of machines and resources. In addition, it is possible to suggest improvement measures on a priority basis to a combination of a plurality of machines, based on the classified occurrence factors. As a result, it is possible to execute more effective improvement measures in sequence, and it is possible to efficiently enhance the productivity of the entire production area constituted by a plurality of machines sharing resources.

FIG. 13 is a diagram illustrating an example of a flowchart of improvement measure derivation processing. Performed in the example of this flowchart is processing of suggesting “(B) plan update after data accumulation”, which is one of improvement measures, to the user based on the statistical data of loss occurrence factors.

First, the improvement measure derivation unit 134 acquires statistical data of the loss occurrence factors in the analysis target period from the loss occurrence factor storage unit 146 (step S201).

The improvement measure derivation unit 134 selects one piece of unselected data from the acquired statistical data of the loss occurrence factors (step S202). For example, the improvement measure derivation unit 134 selects data row #1 in the loss occurrence factor storage unit 146 in FIG. 9.

Then, the improvement measure derivation unit 134 refers to the improvement measure storage unit 147 to derive all the corresponding improvement measures to the selected data loss occurrence factor 146b, and assigns the occurrence frequencies corresponding to the derived improvement measures (step S203).

For example, if the data acquired in step S202 is the data row #1 in the loss occurrence factor storage unit 146 in FIG. 9, the loss occurrence factor 146b of the machine X is “overlapping work between machines X and Y”, and the occurrence frequency 146e is “11%”. According to the example of the improvement measure storage unit 147 in FIG. 10, the improvement measures 147d applicable to the type 147e of the improvement measure “(B) plan update after data accumulation” corresponding to the loss occurrence factor 147c “overlapping work between machines X and Y” are three: “planning of priority of setup work”, “review of product introduction plan”, and “review of personnel plan” (#3, #4, and #5). The improvement measure derivation unit 134 derives all these three improvement measures and assigns the occurrence frequency “11%” to each of the improvement measures.

Similarly, if the data acquired in step S202 is the data row #3 in the loss occurrence factor storage unit 146 in FIG. 9, the loss occurrence factor 146b of the machine X is “incomplete work with machine Y”, and the occurrence frequency 146e is “3%”. According to the example of the improvement measure storage unit 147 in FIG. 10, the improvement measures 147d applicable to the type 147e of the improvement measure “(B) plan update after data accumulation” corresponding to the loss occurrence factor 147c “incomplete work with machine Y” is “review of product introduction plan” (#6). The improvement measure derivation unit 134 derives the improvement measure and assigns the occurrence frequency “3%”.

The improvement measure derivation unit 134 determines whether all the data acquired in step S201 has been selected in step S202 (step S204). If there is unselected data (“No” in step S204), the improvement measure derivation unit 134 returns the control to step S202. If all the data has been selected (“Yes” in step S204), the improvement measure derivation unit 134 moves the control to step S205.

The improvement measure derivation unit 134 integrates the data in which the combination of improvement measure and target machine derived in step S203 is the same, and adds up the occurrence frequencies assigned to the integrated data (step S205). For example, in the loss occurrence factor storage unit 146 in FIG. 9, for the combination of “machine 001” and “machine 002”, the occurrence frequency of 11% from the data row #1 in the process of step S203 is assigned to the improvement measure “review of product introduction plan” as described above. On the other hand, the occurrence frequency of 3% from the data row #3 is assigned to the improvement measure “review of product introduction plan” as described above.

As for the improvement measure “review of product introduction plan” for the combination of the machine X “machine 001” and the machine Y “machine 002”, it can be seen that the effective event has an occurrence frequency of 11%+3%=14% by adding up these two occurrence frequencies. As in the present example, if the same improvement measure is effective for a plurality of different production losses, the priority order of the improvement measures can be quantitatively evaluated by integrating the data of the occurrence frequencies from the viewpoint of the improvement measures. That is, it can be said that improvement measures effective for a plurality of loss occurrence factors can be integrated and reflected in priority order.

The improvement measure derivation unit 134 sorts the combinations of improvement measure and target machine in order of the occurrence frequency (step S206). The improvement measure derivation unit 134 can present the priority order of the improvement measures by sorting the combinations from the viewpoint of improvement measures instead of loss occurrence factors. If there are improvement measures having the same occurrence frequency, the improvement measure derivation unit 134 refers to the definition of the priority order 147f in the improvement measure storage unit 147 in FIG. 10, and determines the priority order.

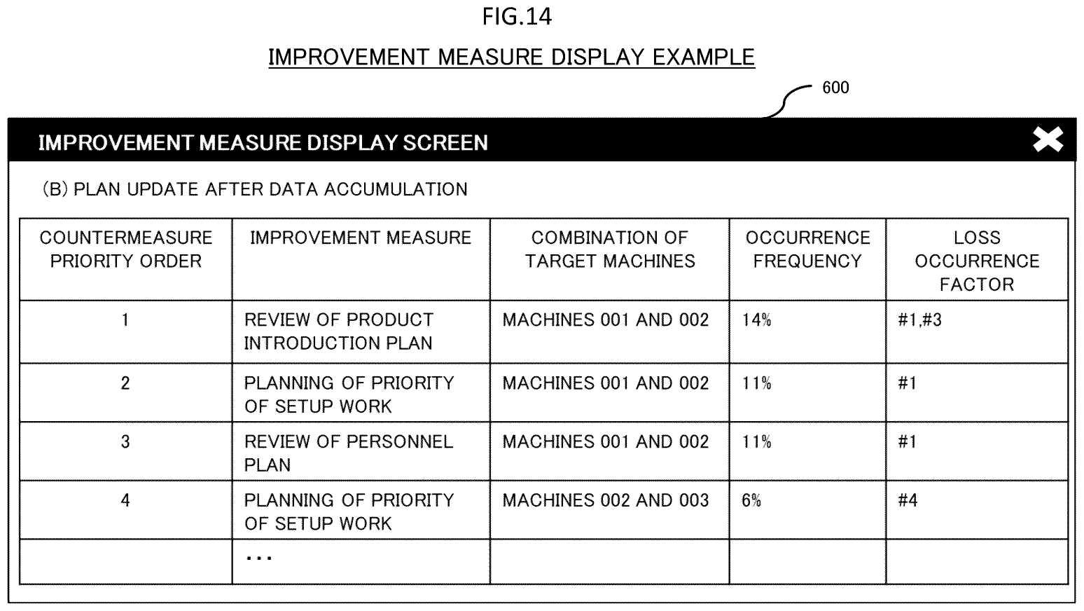

The improvement measure derivation unit 134 displays the sorted results on the screen by the improvement measure display unit 124, and ends the improvement measure derivation processing (step S207). The improvement measure display unit 124 selects and outputs improvement measures corresponding to the production loss information and the loss occurrence factor information. FIG. 14 illustrates an example of this screen display.

FIG. 14 is a diagram illustrating a display example of improvement measures. Displayed on an improvement measure display screen 600 is an example in which, for “(B) plan update after data accumulation” which is one of the improvement measures, if the improvement measure for the loss occurrence factor is the same and the combination of the target machines is the same, the results obtained by adding up the occurrence frequencies and sorting the combinations. That is, the improvement measure display unit 124 rearranges the output improvement measures in order of the occurrence frequency and displays the rearranged improvement measures as the priority order of the improvement measures. For the same improvement measure, if the combination of target machines is the same, it can be said that the duplication is eliminated and the occurrence frequencies are added up.

In the example of the improvement measure display screen 600, the first countermeasure in the priority order is “review of product introduction plan” for the combination of “machine 001” and “machine 002”. The corresponding loss occurrence factors are presented in the data rows #1 and #3 in the loss occurrence factor storage unit 146 in FIG. 9. The sum of the occurrence frequencies is 14% (a breakdown of 11%+3% may be indicated as in the above example).

In the second and third in the priority order of countermeasures, the occurrence frequencies are both 11%. However, according to the definition in the improvement measure storage unit 147 in FIG. 10, the priority of “planning of priority of setup work” is higher than that of “review of product introduction plan”. Therefore, “planning of priority of setup work” is displayed as the second in the priority order.

As described above, in the improvement measure derivation processing, it is possible to suggest the improvement measures for the combination of a plurality of machines in accordance with priority based on the analyzed loss occurrence factors. As a result, it is possible to execute more effective improvement measures in sequence, and it is possible to efficiently enhance the productivity of the entire production area constituted by a plurality of machines sharing resources.

The production information processing apparatus to which the first embodiment according to the present invention is applied has been described above. According to the first embodiment of the present invention, it is possible to plan improvement measures based on the analysis of production losses and to enhance the productivity of the entire production area constituted by a plurality of machines.

[Second Embodiment] The present embodiment basically has the same configuration as that of the first embodiment. However, there is a difference in not only suggesting improvement measures but also performing specific improvement operations. The embodiment will be described taking specific examples.

In the second embodiment, an improvement measure storage unit 147 stores an improvement program in addition to improvement measures 147d. An improvement measure derivation unit 134 derives and implements an improvement program corresponding to an improvement measure selected on the screen among the improvement measures derived in improvement measure deriving processing. The improvement program here is a program for changing a setting value or an operation rule of the machine, for example.

According to the second embodiment of the present invention, it is possible not only to plan improvement measures based on the analysis of production losses, but also to automatically apply the measures to enhance the productivity of the entire production area constituted by a plurality of machines.

The present invention is not limited to the above-described embodiments, and includes various modifications. For example, each of the above-described embodiments has been described in detail in order to make the present invention easy to understand, and the present invention is not necessarily limited to embodiments including all the components described above. Some of the components of one embodiment can be replaced with components of another embodiment, and the components of an embodiment can be added to the components of another embodiment. It is possible to add, delete, and replace some of components to, from, and with others of the components in each embodiment.

Some or all of the above-described components, functions, processing units, processing means, and the like may be implemented by hardware designed with an integrated circuit, for example. The above-described components, functions, and the like may be implemented by software by a processor interpreting and executing programs for performing the functions. Information such as programs, tables, and files for implementing the functions can be stored in a recording device such as a memory, a hard disk, and an SSD, or a recording medium such as an IC card, an SD card, and a DVD.

The control lines and the information lines indicate what is considered to be necessary for the description, and do not necessarily indicate all the control lines and the information lines on the product. In practice, it may be considered that almost all the components are connected to each other.

What is claimed is:

1. A production information processing apparatus comprising: a processor; and a storage device, wherein
the storage device stores:
a shared resource that is a resource shared among a plurality of machines belonging to a predetermined manufacturing area;
4M (Machine, Man, Material, and Method) data information that is time-series data of operating states per unit time of the machines and the resource related to the machines; and
a production loss analysis model that defines a criterion for determining a production loss from a combination of the operating states per unit time in the 4M data information, and
the processor is configured to execute:
identifying a production loss of each of the machines using the 4M data information and the production loss analysis model to generate production loss information; and
combining the production loss information of one of the machines and 4M data information of another of the machines that is different from the machine and shares the resource, using the production loss information and the shared resource, to classify an occurrence factor of the production loss and generate loss occurrence factor information.

2. The production information processing apparatus according to claim 1, wherein
the resource shared by the machines is associated with each combination of two or more machines as the shared resource.

3. The production information processing apparatus according to claim 1, wherein
the storage device
stores a loss occurrence factor analysis model that defines a criterion for determining an occurrence factor of the production loss from a combination of the production loss information of the machine and the operating state per unit time in the 4M data information of the other machine that is different from the machine and shares the resource, and
the processor classifies the occurrence factor of the production loss using the loss occurrence factor analysis model.

4. The production information processing apparatus according to claim 1, further comprising
a display unit configured to display the loss occurrence factor information, wherein
the display unit displays the production loss of a target machine and an occurrence factor of the loss in time series in parallel with a state of another machine sharing a resource with the machine and the shared resource.

5. The production information processing apparatus according to claim 1, wherein
the storage device
stores an improvement measure associated with the production loss and the occurrence factor of the loss, and
the processor
selects and outputs the improvement measure corresponding to the production loss information and the loss occurrence factor information.

6. The production information processing apparatus according to claim 5, wherein
one or more improvement measures are defined for one type of the production loss.

7. The production information processing apparatus according to claim 6, wherein
one or more improvement measures are defined for one type of the production loss, and types of the improvement measures are also defined.

8. The production information processing apparatus according to claim 6, wherein
one or more improvement measures are defined for one type of the production loss, and priorities of the improvement measures are defined.

9. The production information processing apparatus according to claim 5, further comprising
a display unit configured to display the output improvement measures, wherein
the display unit rearranges the output improvement measures in order of occurrence frequency and displays the rearranged improvement measures in order of priority of improvement measures, and if combinations of target machines are the same for the same improvement measure, eliminates duplication and adds up occurrence frequencies.

10. A production information processing system comprising:
a processing unit; and a storage unit, wherein
the storage unit stores:
a shared resource that is a resource shared among a plurality of machines belonging to a predetermined manufacturing area;
4M (Machine, Man, Material, and Method) data information that is time-series data of operating states per unit time of the machines and the resource related to the machines; and
a production loss analysis model that defines a criterion for determining a production loss from a combination of the operating states per unit time in the 4M data information, and
the processing unit is configured to execute:
identifying a production loss of each of the machines using the 4M data information and the production loss analysis model to generate production loss information; and
combining the production loss information of one of the machines and 4M data information of another of the machines that is different from the machine and shares the resource, using the production loss information and the shared resource, to classify an occurrence factor of the production loss and generate loss occurrence factor information.

11. A production information processing method using an information processing apparatus,
the information processing apparatus including: a processor; and a storage device,
the storage device storing:
a shared resource that is a resource shared among a plurality of machines belonging to a predetermined manufacturing area;
4M (Machine, Man, Material, and Method) data information that is time-series data of operating states per unit time of the machines and the resource related to the machines; and
a production loss analysis model that defines a criterion for determining a production loss from a combination of the operating states per unit time in the 4M data information,
the method executed by the processor, comprising:
identifying a production loss of each of the machines using the 4M data information and the production loss analysis model to generate production loss information; and
combining the production loss information of one of the machines and 4M data information of another of the machines that is different from the machine and shares the resource, using the production loss information and the shared resource, to classify an occurrence factor of the production loss and generate loss occurrence factor information.
